(19) United States
(12) Patent Application Publication
(10) Pub. No.: US 2014/0348040 A1
(43) Pub. Date: Nov. 27, 2014

(54) Semi-Full-Duplex Single-Carrier Transmission Technique

(71) Applicants: Wei Hong, Beijing (CN); Chunyan Gao, Beijing (CN); Haiming Wang, Beijing (CN); Pengfei Sun, Beijing (CN); Xinying Gao, Beijing (CN)

(72) Inventors: Wei Hong, Beijing (CN); Chunyan Gao, Beijing (CN); Haiming Wang, Beijing (CN); Pengfei Sun, Beijing (CN); Xinying Gao, Beijing (CN)

(73) Assignee: Broadcom Corporation, Irvine, CA (US)

(21) Appl. No.: 14/366,923

(22) PCT Filed: Dec. 21, 2011
(86) PCT No.: PCT/CN2011/084342

§ 371 Date: Jun. 19, 2014

(51) Int. Cl. H04W 72/12; H04L 5/14

(52) U.S. Cl. CPC H04W 72/1263; H04L 5/14
USPC 370/280

(57) ABSTRACT

There are provided measures for enabling a semi-full-duplex single-carrier transmission technique. Such measures may exemplarily comprise classifying each one of served terminals into one of two transmission groups, assigning an uplink-downlink configuration of a frame structure for time division duplex communication for each one of the two transmission groups such that uplink subframes for one transmission group and downlink subframes of the other transmission group coincide with each other, and scheduling uplink and downlink transmissions for the served terminals on a single carrier according to the assigned uplink-downlink configurations for the two transmission groups.

### FIELD OF THE INVENTION

The present invention relates to a semi-full-duplex single-carrier transmission technique. More specifically, the present invention relates to measures (including methods, apparatuses and computer program products) for enabling a semi-full-duplex single-carrier transmission technique.

### BACKGROUND

In the field of communication systems, including wireless and/or cellular communication systems, various techniques are known for concurrently utilizing a physical channel for both transmitting and receiving operations, i.e. for communication in both transmitting and receiving directions from the viewpoint of a system entity in questions.

One of these known channel utilization techniques is Time Division Duplex (TDD) in which transmitting and receiving channels utilize a common frequency spectrum or carrier while being temporally separated from each other. The TDD technique is effective by offering flexible deployments without requiring a pair of spectrum resources, which is especially beneficial in wireless communication systems having limited spectrum resources. Further, the TDD technique is effective by allowing an asymmetric uplink-downlink (UL-DL) resource allocation in that a different number of resources (e.g. blocks, frames, subframes or the like) are allocated for uplink and downlink communications. In view of these features, TDD is currently utilized in various communication systems, including wireless and/or cellular communication systems, e.g. LTE, LTE-A and WiMAX.

When all system entities communicating with each other use TDD as the channel utilization technique, the thus adopted transmission technique is a half-duplex transmission technique. That is, while the same frequency spectrum or carrier is used for transmitting and receiving operations at each system entity, it is not feasible to simultaneously transmit and receive on the same frequency spectrum or carrier at the same time.

In terms of channel utilization efficiency, it would however be preferable to enable simultaneous transmitting and receiving operations on the same frequency spectrum or carrier at the same time. When all system entities communicating with each other could use such channel utilization technique, the thus adopted transmission technique would be a full-duplex transmission technique.

The full-duplex transmission technique has been known to be feasible in theory for some time, but it has been deemed to be unfeasible in practice so far. Specifically, the full-duplex transmission has been deemed to be an unfeasible concept for mobile communications and device deployments because the device's own transmit signal leaks into its own receiver chain causing problems in detection of wanted signals. Although interference cancellation schemes and other baseband signal processing operations have been constantly developed during the recent years, practically implementing full-duplex transmission is still a huge challenge from the point of view of conventional cellular systems and cellular devices.

While there are recent proposals for achieving full-duplex transmission on the same carrier, there remain challenging problems in terms of complexity of protocol and/or system design. Namely, in a full-duplex transmission technique, at least scheduling and interference cancellation at the communicating system entities, such as eNB and UE, would be highly complicated to be realized.

In view thereof, it is desirable to improve channel utilization efficiency or spectrum efficiency (as compared with a half-duplex transmission technique) while avoiding excessive complexity of protocol and/or system design e.g. in terms of at least scheduling and interference cancellation (as compared with a full-duplex transmission technique).

Thus, there is a desire to improve existing channel utilization techniques or duplex transmission techniques, particularly for single-carrier communications.

### SUMMARY

Various exemplary embodiments of the present invention aim at addressing at least part of the above issues and/or problems and drawbacks.

Various aspects of exemplary embodiments of the present invention are set out in the appended claims.

According to an exemplary aspect of the present invention, there is provided a method comprising classifying each one of served terminals into one of two transmission groups, assigning an uplink-downlink configuration of a frame structure for time division duplex communication for each one of the two transmission groups such that uplink subframes for one transmission group and downlink subframes of the other transmission group coincide with each other, and scheduling uplink and downlink transmissions for the served terminals on a single carrier according to the assigned uplink-downlink configurations for the two transmission groups.

According to an exemplary aspect of the present invention, there is provided a method comprising identifying classification into one of two transmission groups of terminals being served by a serving access node or base station, setting an uplink-downlink configuration of a frame structure for time division duplex communication according to the identified transmission group classification, wherein the set uplink-downlink configuration is such that uplink subframes coincide with downlink subframes of the other transmission group and downlink subframes coincide with uplink subframes of the other transmission group, and scheduling uplink and downlink transmissions on a single carrier according to the set uplink-downlink configuration.

According to an exemplary aspect of the present invention, there is provided an apparatus comprising at least one processor, at least one memory including computer program code, and at least one interface configured for communication with at least another apparatus, the at least one processor, with the at least one memory and the computer program code, being configured to cause the apparatus to perform: classifying each one of served terminals into one of two transmission groups, assigning an uplink-downlink configuration of a frame structure for time division duplex communication for each one of the two transmission groups such that uplink subframes for one transmission group and downlink subframes of the other transmission group coincide with each other, and scheduling uplink and downlink transmissions for the served terminals on a single carrier according to the assigned uplink-downlink configurations for the two transmission groups.

According to an exemplary aspect of the present invention, there is provided an apparatus comprising at least one processor, at least one memory including computer program code, and at least one interface configured for communication with at least another apparatus, the at least one processor, with the at least one memory and the computer program code, being configured to cause the apparatus to perform: identifying classification into one of two transmission groups of terminals being served by a serving access node or base station, setting an uplink-downlink configuration of a frame structure for time division duplex communication according to the identified transmission group classification, wherein the set uplink-downlink configuration is such that uplink subframes coincide with downlink subframes of the other transmission group and downlink subframes coincide with uplink subframes of the other transmission group, and scheduling uplink and downlink transmissions on a single carrier according to the set uplink-downlink configuration.

According to an exemplary aspect of the present invention, there is provided a computer program product comprising computer-executable computer program code which, when the program is run on a computer (e.g. a computer of an apparatus according to any one of the aforementioned apparatus-related exemplary aspects of the present invention), is configured to cause the computer to carry out the method according to any one of the aforementioned method-related exemplary aspects of the present invention.

Such computer program product may comprise or be embodied as a (tangible) computer-readable (storage) medium or the like on which the computer-executable computer program code is stored, and/or the program may be directly loadable into an internal memory of the computer or a processor thereof.

Advantageous further developments or modifications of the aforementioned exemplary aspects of the present invention are set out in the following.

By way of exemplary embodiments of the present invention, there is provided a semi-full-duplex single-carrier transmission technique (in/for cellular communication systems). More specifically, by way of exemplary embodiments of the present invention, there are provided measures and mechanisms for enabling a semi-full-duplex single-carrier transmission technique (in/for cellular communication systems).

Thus, enhancements are achieved by methods, apparatuses and computer program products enabling a semi-full-duplex single-carrier transmission technique (in/for cellular communication systems).

### BRIEF DESCRIPTION OF DRAWINGS

For a more complete understanding of exemplary embodiments of the present invention, reference is now made to the following description taken in connection with the accompanying drawings in which:

FIG. 1 shows a schematic diagram illustrating a system scenario of a semi-full-duplex single-carrier transmission technique according to exemplary embodiments of the present invention,

FIG. 2 shows a flowchart of a procedure being operable at a network entity according to exemplary embodiments of the present invention,

FIG. 3 shows a flowchart of a procedure being operable at a terminal entity according to exemplary embodiments of the present invention,

FIG. 4 shows a schematic diagram illustrating a first example of UL-DL configurations for a transmission group classification according to exemplary embodiments of the present invention,

FIG. 5 shows a schematic diagram illustrating a second example of UL-DL configurations for a transmission group classification according to exemplary embodiments of the present invention,

FIG. 6 shows a schematic diagram illustrating an example of an UL/DL scheduling based on UL-DL configurations for a transmission group classification according to exemplary embodiments of the present invention,

FIG. 7 shows a signaling diagram illustrating a first example of a procedure in terms of transmission group classification according to exemplary embodiments of the present invention,

FIG. 8 shows a signaling diagram illustrating a second example of a procedure in terms of transmission group classification according to exemplary embodiments of the present invention, and

FIG. 9 shows a schematic block diagram illustrating exemplary apparatuses according to exemplary embodiments of the present invention.

### DESCRIPTION OF EXEMPLARY EMBODIMENTS

Exemplary aspects of the present invention will be described herein below. More specifically, exemplary aspects of the present are described hereinafter with reference to particular non-limiting examples and to what are presently considered to be conceivable embodiments of the present invention. A person skilled in the art will appreciate that the invention is by no means limited to these examples, and may be more broadly applied.

It is to be noted that the following description of the present invention and its embodiments mainly refers to specifications being used as non-limiting examples for certain exemplary network configurations and deployments. Namely, the present invention and its embodiments are mainly described in relation to 3GPP specifications being used as non-limiting examples for certain exemplary network configurations and deployments. In particular, a LTE/LTE-Advanced communication system is used as a non-limiting example for the applicability of thus described exemplary embodiments. As such, the description of exemplary embodiments given herein specifically refers to terminology which is directly related thereto. Such terminology is only used in the context of the presented non-limiting examples, and does naturally not limit the invention in any way. Rather, any other network configuration or system deployment, etc. may also be utilized as long as compliant with the features described herein, such as e.g. WiMAX and other systems.

Hereinafter, various embodiments and implementations of the present invention and its aspects or embodiments are described using several alternatives. It is generally noted that, according to certain needs and constraints, all of the described alternatives may be provided alone or in any conceivable combination (also including combinations of individual features of the various alternatives).

According to exemplary embodiments of the present invention, in general terms, there are provided mechanisms, measures and means for enabling a semi-full-duplex single-carrier transmission technique (in/for cellular communication systems).

In the following, exemplary embodiments of the present invention are described with reference to methods, procedures and functions, as well as with reference to structural arrangements and configurations.

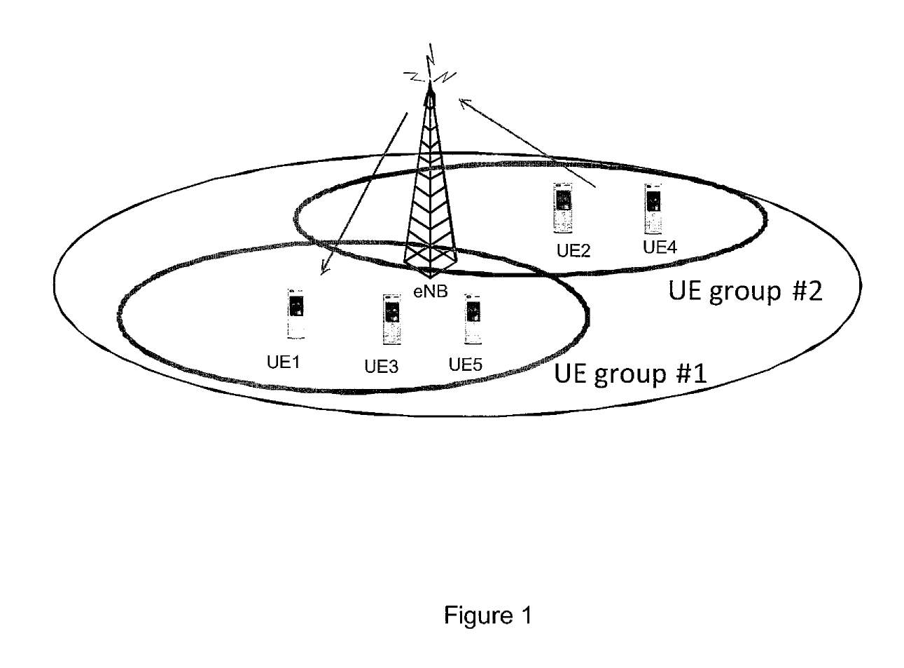

FIG. 1 shows a schematic diagram illustrating a system scenario of a semi-full-duplex single-carrier transmission technique according to exemplary embodiments of the present invention.

As shown in FIG. 1, as an example for describing the exemplary embodiments of the present invention, an assumed system scenario comprises a base station or access node of a cellular communication system, denoted by eNB, as well as at least two terminals or user equipments, denoted by UE1 to UE5. The at least two terminals or user equipments are located in the coverage/service area of the base station or access node, and are thus deemed to be served by (and/or connected to) the base station or access node.

As shown in FIG. 1, the exemplarily illustrated terminals or user equipments UE1 to UE5 are classified into two user groups (also referred to as transmission groups herein). Assuming that the illustration of FIG. 1 depicts a transmission condition on a single carrier at a particular point in time, it is evident that eNB and UE1, UE3, UE5 being classified in UE group #1 perform a DL transmission, while eNB and UE2, UE4 being classified in UE group 2 perform a UL transmission.

Accordingly, the base station or access node realizes a full-duplex transmission technique (i.e. simultaneous transmitting and receiving operations on the same frequency spectrum or carrier at the same time), while the terminals or user equipments realize a half-duplex transmission technique (i.e. only transmitting or receiving operation on the same frequency spectrum or carrier at the same time).

In view thereof, exemplary embodiments of the present invention provide a semi-full-duplex single-carrier transmission technique, including a full-duplex single-carrier operation at a network entity side and a half-duplex single-carrier operation at a terminal entity side.

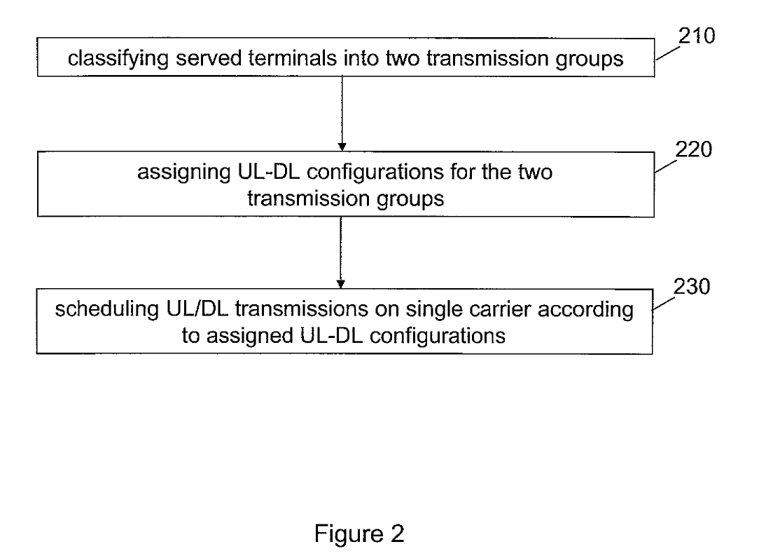

Hereinafter, procedures and functions relating to such semi-full-duplex single-carrier transmission technique according to exemplary embodiments of the present invention are described in more detail with reference to FIGS. 2 to 8.

FIG. 2 shows a flowchart of a procedure being operable at a network entity according to exemplary embodiments of the present invention. The procedure according to FIG. 2 may be carried out at any network entity such as a base station or access node of a cellular communication system, e.g. the eNB according to FIG. 1.

As shown in FIG. 2, a corresponding procedure according to exemplary embodiments of the present invention comprises an operation (210) of classifying each one of served terminals into one of two transmission groups, an operation (220) of assigning an uplink-downlink configuration of a frame structure for time division duplex communication for each one of the two transmission groups such that uplink subframes for one transmission group and downlink subframes of the other transmission group coincide with each other, and an operation (230) of scheduling uplink and downlink transmissions for the served terminals on a single carrier according to the assigned uplink-downlink configurations for the two transmission groups.

According to the above-outlined procedure, a full-duplex single-carrier operation at a network entity side may be realized.

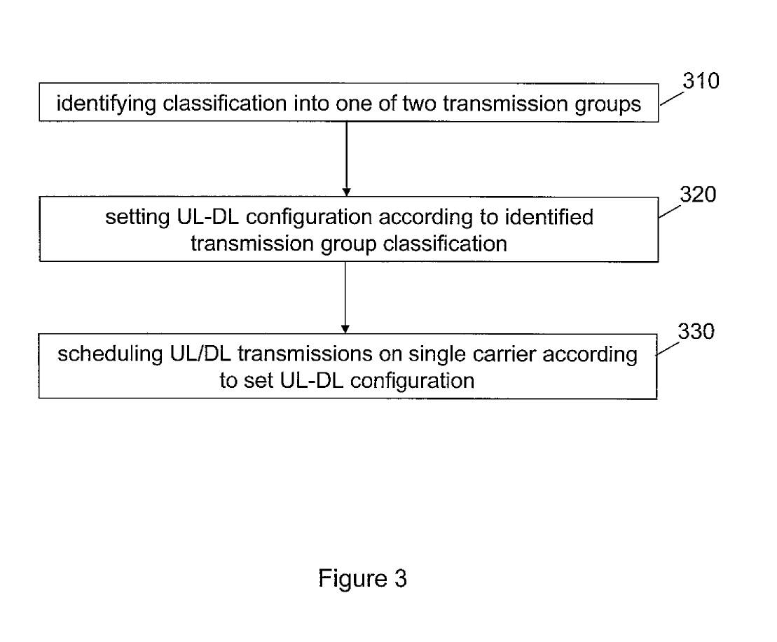

FIG. 3 shows a flowchart of a procedure being operable at a terminal entity according to exemplary embodiments of the present invention. The procedure according to FIG. 3 may be carried out at any terminal entity such as a terminal or user equipment operable in a cellular communication system, e.g. any one of UE1 to UE5 according to FIG. 1.

As shown in FIG. 3, a corresponding procedure according to exemplary embodiments of the present invention comprises an operation (310) of identifying classification into one of two transmission groups of terminals being served by a serving access node or base station, an operation (320) of setting an uplink-downlink configuration of a frame structure for time division duplex communication according to the identified transmission group classification, wherein the set uplink-downlink configuration is such that uplink subframes coincide with downlink subframes of the other transmission group and downlink subframes coincide with uplink subframes of the other transmission group, and an operation (330) of scheduling uplink and downlink transmissions on a single carrier according to the set uplink-downlink configuration.

According to the above-outlined procedure, a half-duplex single-carrier operation at a terminal entity side may be realized.

From a system perspective, after the procedures according to FIGS. 2 and 3, in one TTI/subframe, the eNB schedules DL transmission only for UEs in the same group, while scheduling UL transmission for UEs in another group in the same carrier, and vice versa. That is, each TTI/subframe is configured to be DL for one group of UEs and UL for another group of UEs, and vice versa.

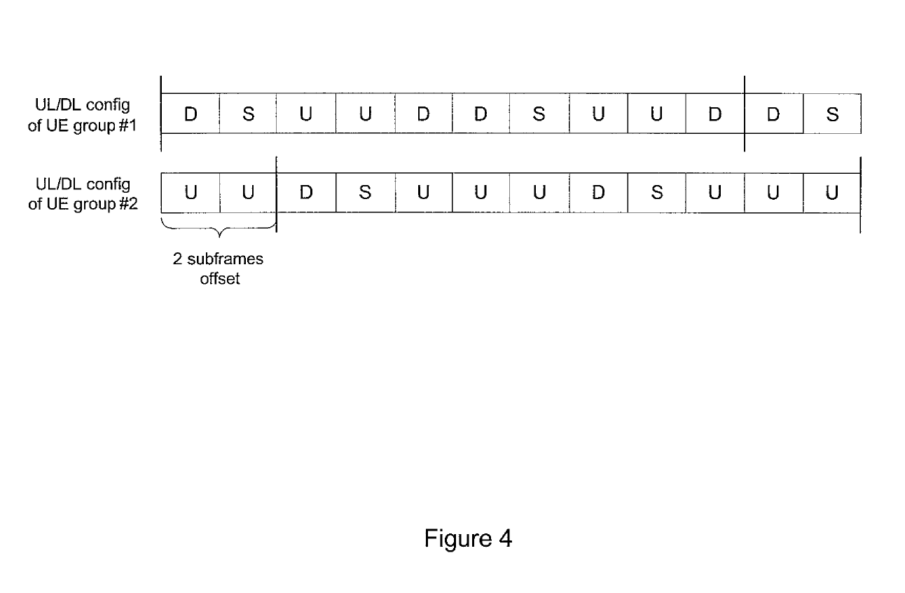

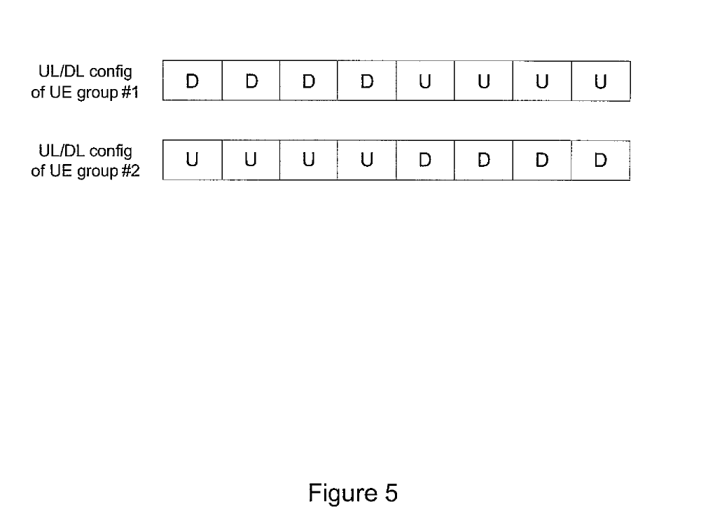

According to exemplary embodiments of the present invention, referring to the exemplary system scenario according to FIG. 1, the eNB may define two transmission or user groups, denoted as “UE group #1” and “UE group #2”. Thereby, a transmission or user classification may be adopted, in which all the served/connected UEs are supposed to be allocated to one of the two groups. By virtue of such transmission or user group classification, the eNB may assign the UL-DL configurations for the individual transmission or user groups such that the UL/DL subframes of the different transmission or user groups are not overlapped, as shown in FIGS. 4 and 5 below. The eNB may then schedule its UL/DL transmissions on the basis of such transmission or user classification and the related UL-DL configuration assignment. Any one of the UEs may identify its membership to one of the two transmission or user groups according to the transmission or user group classification, may set a corresponding UL-DL configuration according to the UL-DL configuration assignment accordingly, and may then schedule its UL/DL transmissions on the basis of such transmission or user classification and the related UL-DL configuration assignment.

According to exemplary embodiments of the present invention, multiple configurations, i.e. assignments of UL-DL configurations, may be designed to allow a different number of full-duplex subframes.

FIG. 4 shows a schematic diagram illustrating a first example of UL-DL configurations for a transmission group classification according to exemplary embodiments of the present invention, wherein D indicates a DL subframe, U indicates an UL subframe, and 5 indicates a special subframe.

As shown in FIG. 4, the UL-DL configuration exemplarily assigned to UE group #1 has the subframe pattern DSUUDDSUUD, while the UL-DL configuration exemplarily assigned to UE group #2 has the subframe pattern DSUUUDSUUU. Further, these two UL-DL configurations of the two groups are offset against each other by two subframes. Thereby, a temporal coincidence of UL/DL subframes of UE group #1 and DL/UL subframes of UE group #2 is realized.

In the exemplary configuration of FIG. 4, the UL-DL configuration used for each one of the two groups corresponds to one of a predefined number of specified UL-DL configurations, e.g. one of the seven semi-statically configured UL-DL configurations being currently specified the context of LTE TDD systems. As long as a temporal coincidence of UL/DL subframes of UE group #1 and DL/UL subframes of UE group #2 is realized, the specified UL-DL configurations for the two groups may also correspond to the same one of a predefined number of specified UL-DL configurations.

In Table 1 below, these specified UL-DL configurations are shown, wherein it is evident that the exemplary UL-DL configurations according to FIG. 4 corresponds to UL-DL configuration #1 for UE group #1 and UL-DL configuration #0 for UE group #2.

TABLE 1

| | | | | | | | | | | |
|---|---|---|---|---|---|---|---|---|---|---|
| 0 | D | S | U | U | U | D | S | U | U | U |
| 1 | D | S | U | U | D | D | S | U | U | D |
| 2 | D | S | U | D | D | D | S | U | D | D |
| 3 | D | S | U | U | U | D | D | D | D | D |
| 4 | D | S | U | U | D | D | D | D | D | D |
| 5 | D | S | U | D | D | D | D | D | D | D |
| 6 | D | S | U | U | U | D | S | U | U | D |

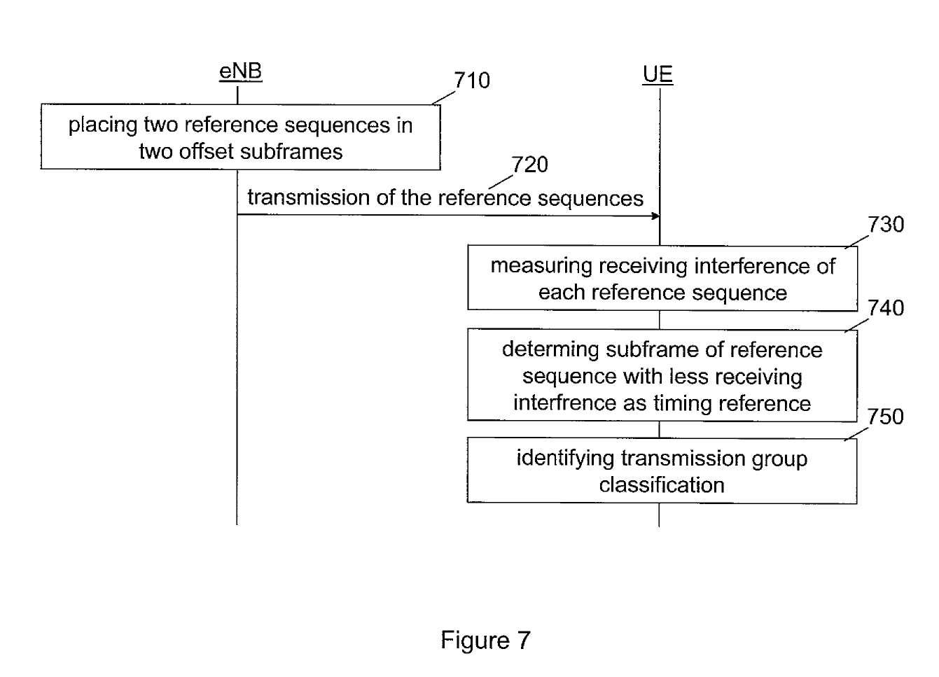

According to exemplary embodiments of the present invention, a group-based UL-DL configuration assignment according to FIG. 4 may for example be established using the exemplary procedure according to FIG. 7 below.

FIG. 5 shows a schematic diagram illustrating a second example of UL-DL configurations for a transmission group classification according to exemplary embodiments of the present invention, wherein D indicates a DL subframe and U indicates an UL subframe.

As shown in FIG. 5, the UL-DL configuration exemplarily assigned to UE group #1 has the subframe pattern DDDDUUUU, while the UL-DL configuration exemplarily assigned to UE group #2 has the subframe pattern UUUUDDDD.

In the exemplary configuration of FIG. 5, the UL-DL configuration used for each one of the two groups do not correspond to one of a predefined number of specified UL-DL configurations, but may constitute arbitrarily designed subframe patterns, as long as a temporal coincidence of UL/DL subframes of UE group #1 and DL/UL subframes of UE group #2 is realized.

As another example for UL-DL configurations for a transmission group classification according to exemplary embodiments, it may be assumed that that the UL-DL configuration assigned to UE group #1 has the subframe pattern DDUUUUDDDD, while the UL-DL configuration exemplarily assigned to UE group #2 has the subframe pattern UUDDDDUUUU.

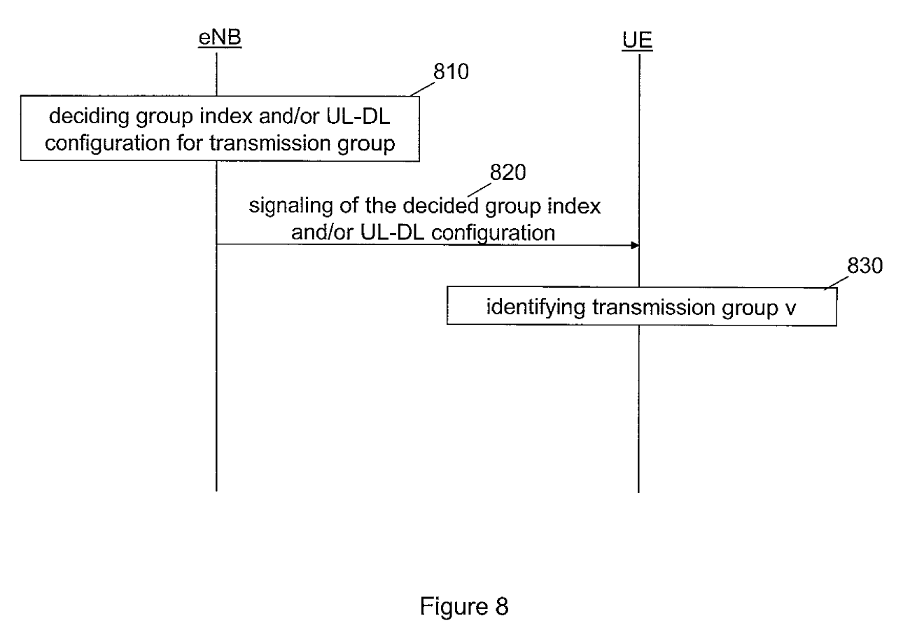

According to exemplary embodiments of the present invention, a group-based UL-DL configuration assignment according to FIG. 5 may for example be established using the exemplary procedure according to FIG. 8 below.

According to exemplary embodiments of the present invention, the assigned uplink-downlink configurations for the two transmission groups comprise uplink-downlink configurations with a period of a predetermined number of subframes. That is to say, UL-DL configurations for a transmission group classification according to exemplary embodiments of the present invention may have any period.

As evident from a comparison of FIGS. 4 and 5 above, while the exemplary UL-DL configurations according to FIG. 4 have a period of 10 subframes, the exemplary UL-DL configurations according to FIG. 5 have a period of 8 subframes. Assuming that each subframe corresponds to a time of 1 ms, the temporal period of the two examples according to FIGS. 4 and 5 would thus be 10 ms and 8 ms, respectively.

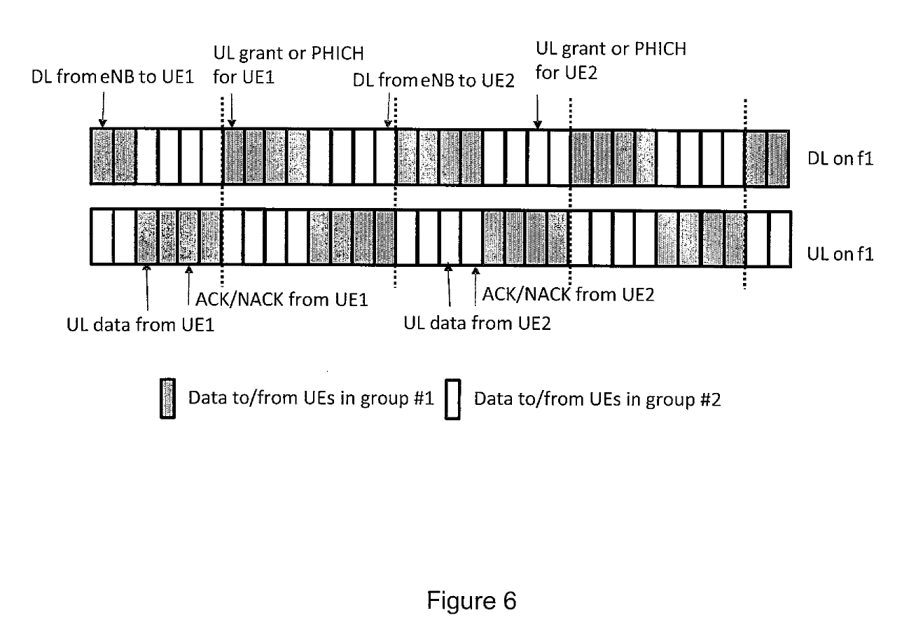

FIG. 6 shows a schematic diagram illustrating an example of an UL/DL scheduling based on UL-DL configurations for a transmission group classification according to exemplary embodiments of the present invention. By way of example only, the exemplary scheduling according to FIG. 6 is assumed to be based on the exemplary UL-DL configuration assignment according to FIG. 5 above, as indicated by vertical dotted lines.

As shown in FIG. 6, the upper row relates to a DL operation on an exemplary frequency f1, and the lower row relates to a UL operation on the exemplary frequency f1, wherein the frequency f1 represents a single carrier. The indicated operations/transmissions are to be understood to start at the subframe/time where the corresponding arrow points, respectively.

As evident from the scheduling example according to FIG. 6, the UL- and DL-scheduled subframes for different groups are temporally coincident, while the UL- and DL-scheduled subframes for the same group are temporally shifted. Namely, it is evident that both a DL operation (with respect to one group) and a UL operation (with respect to the other group) are simultaneously scheduled/performed in each subframe, i.e. at each time, and it is evident that, from the point of view of the UE/UEs in any one of the two groups, only a DL operation or a UL operation is scheduled/performed in each subframe, i.e. at each time.

FIG. 7 shows a signaling diagram illustrating a first example of a procedure in terms of transmission group classification according to exemplary embodiments of the present invention.

As shown in FIG. 7, at the network entity side, a corresponding procedure according to exemplary embodiments of the present invention may comprise an operation (710) of placing a reference sequence for each one of the two transmission groups in a subframe such that the two reference sequences for the two transmission groups are contained in two subframes which are offset against each other by a predetermined number of subframes, and an operation (720) of sending the two reference sequences for the two transmission groups to the served terminals. At the terminal entity side, a corresponding procedure according to exemplary embodiments of the present invention may comprise an operation (720) of receiving, the from serving access node or base station, two reference sequences in two subframes which are offset against each other by a predetermined number of subframes, wherein each reference sequence is associated with one of the two transmission groups, an operation (730) of measuring an interference in receiving each of the two reference sequences, an operation (740) of determining the subframe, in which the reference sequence being received with less interference is contained, as a timing reference, and an operation (750) of identifying the transmission group classification according to the determined timing reference.

According to exemplary embodiments of the present invention, the reference sequence for each one of the two transmission groups comprises a primary or secondary synchronization signal (PSS/SSS).

In view thereof, an (automatic) group selection according to exemplary embodiments of the present invention on the basis of the procedure according to FIG. 7 may be as follows. Such (automatic) group selection may be performed for/by any terminal entity in the coverage/service area of a network entity in question.

The eNB may place and transmit two PSS/SSS or similar sequences in offseted subframes, i.e. subframes for different transmission times, one for each of the two groups. For example, referring to the exemplary configuration according to FIG. 4, the PSS/SSS may be placed in the first subframe of UE group #1 and in the third subframe of UE group #2. Then, each UE may identify the PSS/SSS, i.e. the corresponding subframe, with less interference as the timing reference. In this way, for example, if UE #A is placed near to a number of UEs in UE group #1 and starts to search for PSS/SSS, the PSS/SSS placed in the third subframe of UE group #2 will suffer strong interference from UL transmissions of these neighboring UEs. However, the PSS/SSS placed in the first subframe of UE group #1 will be rather clean, i.e. suffer less interference. Consequently, UE #A may determine the first subframe as the timing reference, and based thereon automatically select UE group #1 as the operating UE group, i.e. identify UE group #1 as the transmission group classification. Thereby, the interference for the corresponding communication is also reduced.

According to exemplary embodiments of the present invention, a procedure according to FIG. 7 may for example be employed for/in initial group selection.

FIG. 8 shows a signaling diagram illustrating a second example of a procedure in terms of transmission group classification according to exemplary embodiments of the present invention.

As shown in FIG. 8, at the network entity side, a corresponding procedure according to exemplary embodiments of the present invention may comprise an operation (810) of deciding at least one of a group index and an uplink-downlink configuration for one of the two transmission groups, and an operation (820) of signaling the decided at least one of the group index and the uplink-downlink configuration to at least one of the served terminals. At the terminal entity side, a corresponding procedure according to exemplary embodiments of the present invention may comprise an operation (820) of receiving, from the serving access node or base station, at least one of a group index and an uplink-downlink configuration for one of the two transmission groups to at least one of the served terminals, and an operation (830) of identifying the transmission group classification according to the received at least one of the group index and the uplink-downlink configuration.

In view thereof, an (automatic) group selection according to exemplary embodiments of the present invention on the basis of the procedure according to FIG. 8 may be as follows. Such (automatic) group selection may be performed for/by any terminal entity in the coverage/service area of a network entity in question.

The eNB should advantageously be able to dynamically change any UE's operating group (i.e. timing and DL/UL pattern) after an UE has connected to the network. To this end, the eNB may decide and signal a corresponding group index and/or a corresponding UL-DL configuration (i.e. subframe pattern) in a configuration signaling to the UE in question. Thereupon, the UE may identify the eNB-controlled UE group classification on the basis of the received group index when the UL-DL pattern is known implicitly or on the basis of the received UL-DL pattern.

According to exemplary embodiments of the present invention, the signaling may comprise sending a bitmap indication of the least one of the group index and the uplink-downlink configuration, or the signaling may comprise sending an indication of one of a predefined number of specified uplink-downlink configurations and an offset of a predetermined number of subframes.

In the case of a signaling based on a bitmap indication, a radio resource control (RRC) message or transmission may be used for signaling the respective information. Thereby, any freely/arbitrarily designed subframe patterns may be efficiently signaled, for example.

For example, such signaling may be accomplished in a pre-specified RRC information element, such as RadioResourceConfigDedicated. This may for example be realized as follows, assuming that a frame period of 8 subframes is adopted.

```
RadioResourceConfigDedicated
RadioResourceConfigDedicatedFullDuplex ::= SEQUENCE {
  -- UE specific configuration extensions applicable for an Full
  Duplex carrier
  physicalConfigDedicatedFullDuplex PhysicalConfignedicatedFuliDuplex
  OPTIONAL, -- Need ON
. . .
}
PhysicalConfigDedicatedFullDuplex
```

| | |
|---|---|
| PhysicalConfigDedicatedFullDuplex ::= | SEQUENCE { |
| UEGroupindex | ENUMERATED {1, 2), |
| UEGroupSubframeConfiguration | BIT STRING (SIZE (8)), |
| } | |

In the case of a signaling based on an indication of specified uplink-downlink configuration and offset, i.e. offset indication, the number of the specified uplink-downlink configuration and the offset in terms of a number of subframes may be signaled. Thereby, any pre-designed subframe patterns may be efficiently signaled, for example.

For example, referring to the exemplary configuration of FIG. 4 and Table 1 above, UL-DL configuration #1 and offset 0 may be signaled for UE group #1, and UL-DL configuration #0 and offset 2 may be signaled for UE group #2.

According to exemplary embodiments of the present invention, a procedure according to FIG. 8 may for example be employed for/in network-controlled group selection/change.

In view of the above, exemplary embodiments of the present invention may provide the following beneficial technical effects.

Basically, a semi-full-duplex single-carrier transmission technique or system, including a full-duplex single-carrier operation at a network entity side and a half-duplex single-carrier operation at a terminal entity side, may be achieved.

In this regard, an improve channel utilization efficiency or spectrum efficiency (as compared with a half-duplex transmission technique) may be achieved, while avoiding excessive complexity of protocol and/or system design e.g. in terms of at least scheduling and interference cancellation (as compared with a full-duplex transmission technique). Also, significant performance gain can be expected in view of the network entity side is supporting full-duplex, while the complexity on the terminal entity side is not remarkably increased.

Further, the UL-DL configurations, i.e. subframe patterns, are configurable/adjustable, thereby enabling balancing between improvement in channel utilization efficiency or spectrum efficiency and increase in complexity. Accordingly, a flexible configuration scheme may be provided, which may also take into account factors regarding UL-DL asymmetry or the like.

Generally, the above-described procedures and functions may be implemented by respective functional elements, processors, or the like, as described below.

While in the foregoing exemplary embodiments of the present invention are described mainly with reference to methods, procedures and functions, corresponding exemplary embodiments of the present invention also cover respective apparatuses, network nodes and systems, including both software and/or hardware thereof.

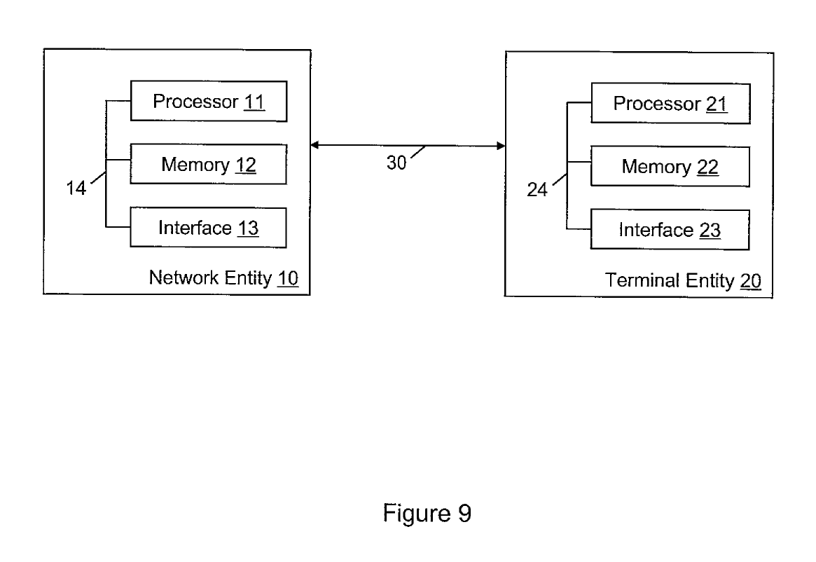

Respective exemplary embodiments of the present invention are described below referring to FIG. 9, while for the sake of brevity reference is made to the detailed description with regard to FIGS. 1 to 8.

In FIG. 9 below, which is noted to represent a simplified block diagram, the solid line blocks are basically configured to perform respective operations as described above. The entirety of solid line blocks are basically configured to perform the methods and operations as described above, respectively. With respect to FIG. 9, it is to be noted that the individual blocks are meant to illustrate respective functional blocks implementing a respective function, process or procedure, respectively. Such functional blocks are implementation-independent, i.e. may be implemented by means of any kind of hardware or software, respectively. The arrows and lines interconnecting individual blocks are meant to illustrate an operational coupling there-between, which may be a physical and/or logical coupling, which on the one hand is implementation-independent (e.g. wired or wireless) and on the other hand may also comprise an arbitrary number of intermediary functional entities not shown. The direction of arrow is meant to illustrate the direction in which certain operations are performed and/or the direction in which certain data is transferred.

Further, in FIG. 9, only those functional blocks are illustrated, which relate to any one of the above-described methods, procedures and functions. A skilled person will acknowledge the presence of any other conventional functional blocks required for an operation of respective structural arrangements, such as e.g. a power supply, a central processing unit, respective memories or the like. Among others, memories are provided for storing programs or program instructions for controlling the individual functional entities to operate as described herein.

FIG. 9 shows a schematic block diagram illustrating exemplary apparatuses according to exemplary embodiments of the present invention.

In view of the above, the thus described apparatuses 10 and 20 are suitable for use in practicing the exemplary embodiments of the present invention, as described herein. The thus described apparatus 10 may represent a (part of an) network entity, such as a base station or access node, e.g. eNB of FIG. 1, or a modem (which may be installed as part of such network entity, but may be also a separate module, which can be attached to various devices, as described above), and may be configured to perform a procedure and/or functionality as described in conjunction with any one of FIGS. 1, 2, 6 and 7. The thus described apparatus 20 may represent a (part of a) terminal entity, such as a terminal or mobile station or user equipment, e.g. one of UE1 to UE5 of FIG. 1, or a modem (which may be installed as part of a UE, but may be also a separate module, which can be attached to various devices, as described above), and may be configured to perform a procedure and/or functionality as described in conjunction with any one of FIGS. 1, 3, 6 and 8.

According to exemplary embodiments of the present invention, any one of the thus illustrated apparatuses 10 and 20 may be operable in any conceivable wireless and/or cellular communication system, e.g. LTE, LTE-A and WiMAX, or the like.

An terminal entity according to exemplary embodiments of the present invention may for example comprise any (short range, cellular, satellite, etc.) wireless communication device such as car communication devices, mobile phones, smart phones, communicators, USB devices, laptops, finger computers, machine-to-machine terminals, device-to-device terminals, routers, terminals of pico/micro/femto cells and the like with wireless communication capability, and so on.

As indicated in FIG. 9, according to exemplary embodiments of the present invention, each of the apparatuses comprises a processor 11/22, a memory 12/22 and an interface 13/23, which are connected by a bus 14/24 or the like, and the apparatuses may be connected via a link 30. The link 30 may be a physical and/or logical coupling, which is implementation-independent (e.g. wired or wireless).

The processor 11/21 and/or the interface 13/23 may be facilitated for communication over a (hardwire or wireless) link, respectively. The interface 13/23 may comprise a suitable receiver or a suitable transmitter-receiver combination or transceiver, which is coupled to one or more antennas or communication means for (hardwire or wireless) communications with the linked or connected device(s), respectively. The interface 13/23 is generally configured to communicate with another apparatus, i.e. the interface thereof.

The memory 12/22 may store respective programs assumed to include program instructions or computer program code that, when executed by the respective processor, enables the respective electronic device or apparatus to operate in accordance with the exemplary embodiments of the present invention. For example, the memory 12/22 may store pre-specified or configured UL-DL configurations, information regarding the classification of terminal entities, and the like.

In general terms, the respective devices/apparatuses (and/or parts thereof) may represent means for performing respective operations and/or exhibiting respective functionalities, and/or the respective devices (and/or parts thereof) may have functions for performing respective operations and/or exhibiting respective functionalities.

When in the subsequent description it is stated that the processor (or some other means) is configured to perform some function, this is to be construed to be equivalent to a description stating that at least one processor, potentially in cooperation with computer program code stored in the memory of the respective apparatus, is configured to cause the apparatus to perform at least the thus mentioned function. Also, such function is to be construed to be equivalently implementable by specifically configured means for performing the respective function (i.e. the expression “processor configured to [cause the apparatus to] perform xxx-ing” is construed to be equivalent to an expression such as “means for xxx-ing”).

According to exemplary embodiments of the present invention, an apparatus representing the apparatus 10 comprises at least one processor 11, at least one memory 12 including computer program code, and at least one interface 13 configured for communication with at least another apparatus. The processor (i.e. the at least one processor 11, with the at least one memory 12 and the computer program code) is configured to perform classifying each one of served terminals into one of two transmission groups, assigning an uplink-downlink configuration of a frame structure for time division duplex communication for each one of the two transmission groups such that uplink subframes for one transmission group and downlink subframes of the other transmission group coincide with each other, and scheduling uplink and downlink transmissions for the served terminals on a single carrier according to the assigned uplink-downlink configurations for the two transmission groups.

According to exemplary embodiments of the present invention, the processor (i.e. the at least one processor 11, with the at least one memory 12 and the computer program code) may be configured to:
placing a reference sequence for each one of the two transmission groups in a subframe such that the two reference sequences for the two transmission groups are contained in two subframes which are offset against each other by a predetermined number of subframes, and sending the two reference sequences for the two transmission groups to the served terminals, and/or
deciding at least one of a group index and an uplink-downlink configuration for one of the two transmission groups, and signaling the decided at least one of the group index and the uplink-downlink configuration to at least one of the served terminals.

According to exemplary embodiments of the present invention, an apparatus representing the network entity 20 comprises at least one processor 20, at least one memory 22 including computer program code, and at least one interface 23 configured for communication with at least another apparatus. The processor (i.e. the at least one processor 21, with the at least one memory 22 and the computer program code) is configured to perform identifying classification into one of two transmission groups of terminals being served by a serving access node or base station, setting an uplink-downlink configuration of a frame structure for time division duplex communication according to the identified transmission group classification, wherein the set uplink-downlink configuration is such that uplink subframes coincide with downlink subframes of the other transmission group and downlink subframes coincide with uplink subframes of the other transmission group, and scheduling uplink and downlink transmissions on a single carrier according to the set uplink-downlink configuration.

According to exemplary embodiments of the present invention, the processor (i.e. the at feast one processor 21, with the at least one memory 22 and the computer program code) may be configured to perform:
receiving, the from serving access node or base station, two reference sequences in two subframes which are offset against each other by a predetermined number of subframes, wherein each reference sequence is associated with one of the two transmission groups, measuring an interference in receiving each of the two reference sequences, determining the subframe, in which the reference sequence being received with less interference is contained, as a timing reference, and identifying the transmission group classification according to the determined timing reference, and/or
receiving, from the serving access node or base station, at least one of a group index and an uplink-downlink configuration for one of the two transmission groups to at least one of the served terminals, and identifying the transmission group classification according to the received at least one of the group index and the uplink-downlink configuration.

As outlined above, for example, the uplink-downlink configurations for the two transmission groups may comprise subframe patterns of a predefined number of specified uplink-downlink configurations, which are offset against each other by a predetermined number of subframes, the uplink-downlink configurations for the two transmission groups may comprise arbitrarily designed subframe patterns, and the uplink-downlink configurations for the two transmission groups may comprise uplink-downlink configurations with a period of a predetermined number of subframes.

For further details of specifics regarding functionalities according to exemplary embodiments of the present invention, reference is made to the foregoing description in conjunction with FIGS. 1 to 8.

According to exemplarily embodiments of the present invention, a system may comprise any conceivable combination of the thus depicted devices/apparatuses and other network elements, which are configured to cooperate as described above.

In general, it is to be noted that respective functional blocks or elements according to above-described aspects can be implemented by any known means, either in hardware and/or software, respectively, if it is only adapted to perform the described functions of the respective parts. The mentioned method steps can be realized in individual functional blocks or by individual devices, or one or more of the method steps can be realized in a single functional block or by a single device.

Generally, any procedural step or functionality is suitable to be implemented as software or by hardware without changing the idea of the present invention. Such software may be software code independent and can be specified using any known or future developed programming language, such as e.g. Java, C++, C, and Assembler, as long as the functionality defined by the method steps is preserved. Such hardware may be hardware type independent and can be implemented using any known or future developed hardware technology or any hybrids of these, such as MOS (Metal Oxide Semiconductor), CMOS (Complementary MOS), BiMOS (Bipolar MOS), BiCMOS (Bipolar CMOS), ECL (Emitter Coupled Logic), TTL (Transistor-Transistor Logic), etc., using for example ASIC (Application Specific IC (Integrated Circuit)) components, FPGA (Field-programmable Gate Arrays) components, CPLD (Complex Programmable Logic Device) components or DSP (Digital Signal Processor) components. A device/apparatus may be represented by a semiconductor chip, a chipset, system in package, or a (hardware) module comprising such chip or chipset; this, however, does not exclude the possibility that a functionality of a device/apparatus or module, instead of being hardware implemented, be implemented as software in a (software) module such as a computer program or a computer program product comprising executable software code portions for execution/being run on a processor. A device may be regarded as a device/apparatus or as an assembly of more than one device/apparatus, whether functionally in cooperation with each other or functionally independently of each other but in a same device housing, for example.

Apparatuses and/or means or parts thereof can be implemented as individual devices, but this does not exclude that they may be implemented in a distributed fashion throughout the system, as long as the functionality of the device is preserved. Such and similar principles are to be considered as known to a skilled person.

Software in the sense of the present description comprises software code as such comprising code means or portions or a computer program or a computer program product for performing the respective functions, as well as software (or a computer program or a computer program product) embodied on a tangible medium such as a computer-readable (storage) medium having stored thereon a respective data structure or code means/portions or embodied in a signal or in a chip, potentially during processing thereof.

The present invention also covers any conceivable combination of method steps and operations described above, and any conceivable combination of nodes, apparatuses, modules or elements described above, as long as the above-described concepts of methodology and structural arrangement are applicable.

In view of the above, the present invention and/or exemplary embodiments thereof provide measures for enabling a semi-full-duplex single-carrier transmission technique. Such measures may exemplarily comprise classifying each one of served terminals into one of two transmission groups, assigning an uplink-downlink configuration of a frame structure for time division duplex communication for each one of the two transmission groups such that uplink subframes for one transmission group and downlink subframes of the other transmission group coincide with each other, and scheduling uplink and downlink transmissions for the served terminals on a single carrier according to the assigned uplink-downlink configurations for the two transmission groups.

Even though the present invention and/or exemplary embodiments are described above with reference to the examples according to the accompanying drawings, it is to be understood that they are not restricted thereto. Rather, it is apparent to those skilled in the art that the present invention can be modified in many ways without departing from the scope of the inventive idea as disclosed herein.

### LIST OF ACRONYMS AND ABBREVIATIONS

### 3GPP Third Generation Partnership Project

### DL Downlink

eNB evolved Node B (E-UTRAN base station)

### LTE Long Term Evolution

### LTE-A Long Term Evolution Advanced

### RRC Radio Resource Control

### TDD Time Division Duplex

### TTI Transmission Time Interval

### UE User Equipment

### UL Uplink

WiMAX Worldwide Interoperability for Microwave Access

1. A method comprising
classifying each one of served terminals into one of two transmission groups,
assigning an uplink-downlink configuration of a frame structure for time division duplex communication for each one of the two transmission groups such that uplink subframes for one transmission group and downlink subframes of the other transmission group coincide with each other, and
scheduling uplink and downlink transmissions for the served terminals on a single carrier according to the assigned uplink-downlink configurations for the two transmission groups.

2. The method according to claim 1, wherein
the assigned uplink-downlink configurations for the two transmission groups comprise subframe patterns of a predefined number of specified uplink-downlink configurations, which are offset against each other by a predetermined number of subframes, or
the assigned uplink-downlink configurations for the two transmission groups comprise at least one of arbitrarily designed subframe patterns and uplink-downlink configurations with a period of a predetermined number of subframes.

3. (canceled)

4. The method according to claim 1, wherein the classifying comprises
placing a reference sequence for each one of the two transmission groups in a subframe such that the two reference sequences for the two transmission groups are contained in two subframes which are offset against each other by a predetermined number of subframes, and
sending the two reference sequences for the two transmission groups to the served terminals, wherein the reference sequence for each one of the two transmission groups comprises a primary or secondary synchronization signal.

5. (canceled)

6. The method according to claim 1, wherein the classifying comprises
deciding at least one of a group index and an uplink-downlink configuration for one of the two transmission groups, and
signaling the decided at least one of the group index and the uplink-downlink configuration to at least one of the served terminals, wherein
the signaling comprises sending a bitmap indication of the least one of the group index and the uplink-downlink configuration, or
the signaling comprises sending an indication of one of a predefined number of specified uplink-downlink configurations and an offset of a predetermined number of subframes.

7-16. (canceled)

17. An apparatus comprising
at least one processor,
at least one memory including computer program code, and
at least one interface configured for communication with at least another apparatus,
the at least one processor, with the at least one memory and the computer program code, being configured to cause the apparatus to:
classify each one of served terminals into one of two transmission groups,
assign an uplink-downlink configuration of a frame structure for time division duplex communication for each one of the two transmission groups such that uplink subframes for one transmission group and downlink subframes of the other transmission group coincide with each other, and
schedule uplink and downlink transmissions for the served terminals on a single carrier according to the assigned uplink-downlink configurations for the two transmission groups.

18. The apparatus according to claim 17, wherein
the assigned uplink-downlink configurations for the two transmission groups comprise subframe patterns of a predefined number of specified uplink-downlink configurations, which are offset against each other by a predetermined number of subframes, or
the assigned uplink-downlink configurations for the two transmission groups comprise arbitrarily designed subframe patterns.

19. The apparatus according to claim 17, wherein
the assigned uplink-downlink configurations for the two transmission groups comprise uplink-downlink configurations with a period of a predetermined number of subframes.

20. The apparatus according to claim 17, wherein the at least one processor, with the at least one memory and the computer program code, is configured to cause the apparatus to:
place a reference sequence for each one of the two transmission groups in a subframe such that the two reference sequences for the two transmission groups are contained in two subframes which are offset against each other by a predetermined number of subframes, and
send the two reference sequences for the two transmission groups to the served terminals.

21. The apparatus according to claim 20, wherein the reference sequence for each one of the two transmission groups comprises a primary or secondary synchronization signal.

22. The apparatus according to claim 17, wherein the at least one processor, with the at least one memory and the computer program code, is configured to cause the apparatus to:
decide at least one of a group index and an uplink-downlink configuration for one of the two transmission groups, and
signal the decided at least one of the group index and the uplink-downlink configuration to at least one of the served terminals.

23. The apparatus according to claim 22, wherein
the signaling comprises sending a bitmap indication of the least one of the group index and the uplink-downlink configuration, or
the signaling comprises sending an indication of one of a predefined number of specified uplink-downlink configurations and an offset of a predetermined number of subframes.

24. The apparatus according to claim 17, wherein
the apparatus is operable as or at an access node, base station or modem of a cellular communication system, and/or
the apparatus is operable in at least one of a LTE, a LTE-A, and a WiMAX system.

25. An apparatus comprising
at least one processor,
at least one memory including computer program code, and
at least one interface configured for communication with at least another apparatus,
the at least one processor, with the at least one memory and the computer program code, being configured to cause the apparatus to:
identify classification into one of two transmission groups of terminals being served by a serving access node or base station,
set an uplink-downlink configuration of a frame structure for time division duplex communication according to the identified transmission group classification, wherein the set uplink-downlink configuration is such that uplink subframes coincide with downlink subframes of the other transmission group and downlink subframes coincide with uplink subframes of the other transmission group, and
schedule uplink and downlink transmissions on a single carrier according to the set uplink-downlink configuration.

26. The apparatus according to claim 25, wherein
the set uplink-downlink configuration comprises a subframe pattern of a predefined number of specified uplink-downlink configurations with or without an offset by a predetermined number of subframes, or
the set uplink-downlink configuration comprises an arbitrarily designed subframe pattern.

27. The apparatus according to claim 25, wherein the set uplink-downlink configuration comprises an uplink-downlink configuration with a period of a predetermined number of subframes.

28. The apparatus according to claim 25, wherein the at least one processor, with the at least one memory and the computer program code, is configured to cause the apparatus to:
receive, from the serving access node or base station, two reference sequences in two subframes which are offset against each other by a predetermined number of subframes, wherein each reference sequence is associated with one of the two transmission groups,
measure an interference in receiving each of the two reference sequences,
determine the subframe, in which the reference sequence being received with less interference is contained, as a timing reference, and
identify the transmission group classification according to the determined timing reference.

29. The apparatus according to claim 28, wherein the reference sequence for each one of the two transmission groups comprises a primary or secondary synchronization signal.

30. The apparatus according to claim 25, wherein the at least one processor, with the at least one memory and the computer program code, is configured to cause the apparatus to perform:
receiving, from the serving access node or base station, at least one of a group index and an uplink-downlink configuration for one of the two transmission groups to at least one of the served terminals, and
identifying the transmission group classification according to the received at least one of the group index and the uplink-downlink configuration.

31. The apparatus according to claim 30, wherein
the receiving comprises receiving a bitmap indication of the least one of the group index and the uplink-downlink configuration, or
the receiving comprises receiving an indication of one of a predefined number of specified uplink-downlink configurations and an offset of a predetermined number of subframes.

32. The apparatus according to claim 25, wherein
the apparatus is operable as or at a terminal, user equipment or modem operable in a cellular communication system, and/or
the apparatus is operable in at least one of a LTE, a LTE-A, and a WiMAX system.

33-34. (canceled)
